(19) United States
(12) Patent Application Publication
(10) Pub. No.: US 2013/0293477 A1
(43) Pub. Date: Nov. 7, 2013

(54) ELECTRONIC APPARATUS AND METHOD FOR OPERATING THE SAME

(71) Applicants: Yi-Fu Chen, Taipei City (TW); Yu-Hsu Pei, Taipei City (TW); Zhi-Sheng Lin, Taipei City (TW); Wei-Han Hu, Taipei City (TW); Wei-Jung Chen, Taipei City (TW); Wen-Hung Lo, Taipei City (TW); Hsin-pei Tsai, Taipei City (TW); Ming-Che Weng, Taipei City (TW); Li-Wei Chen, Taipei City (TW); Po-Hsien Yang, Taipei City (TW); Chun-Sheng Chen, Taipei City (TW)

(72) Inventors: Yi-Fu Chen, Taipei City (TW); Yu-Hsu Pei, Taipei City (TW); Zhi-Sheng Lin, Taipei City (TW); Wei-Han Hu, Taipei City (TW); Wei-Jung Chen, Taipei City (TW); Wen-Hung Lo, Taipei City (TW); Hsin-pei Tsai, Taipei City (TW); Ming-Che Weng, Taipei City (TW); Li-Wei Chen, Taipei City (TW); Po-Hsien Yang, Taipei City (TW); Chun-Sheng Chen, Taipei City (TW)

(73) Assignee: COMPAL ELECTRONICS, INC., Taipei City (TW)

(21) Appl. No.: 13/871,004

(22) Filed: Apr. 26, 2013

Related U.S. Application Data
(60) Provisional application No. 61/641,921, filed on May 3, 2012.

(51) Int. Cl. G06F 3/02

(52) U.S. Cl. CPC G06F 3/02
USPC 345/168

(57) ABSTRACT

An electronic apparatus and an operation method thereof are provided. The electronic apparatus has a sensor module. A space operation mode is enabled when an operation object is detected in a sensor space by the sensor module. A controlling function corresponding to one of a plurality of using spaces divided from the sensor space in which the operation object is located is enabled. Movement information of the operation object is detected by the sensor module, and an operation action corresponding to the enabled controlling function is executed.

### CROSS-REFERENCE TO RELATED APPLICATION

This application claims the priority benefits of U.S. provisional application Ser. No. 61/641,921, filed on May 3, 2012. The entirety of the above-mentioned patent application is hereby incorporated by reference herein and made a part of this specification.

### BACKGROUND

1. Technical Field

The invention relates to an electronic apparatus and a method for operating the same. Particularly, the invention relates to an electronic apparatus capable of operating in a stereoscopic space and a method for operating the same.

2. Related Art

Since a notebook computer with a small volume and a lightweight is easy to carry, it is gradually popularised. Therefore, the notebook computer is an important tool for inquiring, inputting and processing data at anytime anywhere in business activity, plus an advantage of querying remote data through mobile Internet, the notebook computer becomes an indispensable tool in business activity.

Regarding a current notebook computer, a trackpad is generally set at a palmrest region to facilitate user's operation and input. However, since the trackpad generally occupies an operation region with a quite large area, under a trend of lightness, thinness, shortness, smallness and easy to carry of the notebook computer, configuration of the other components on a base such as a keyboard, etc. is influenced. Moreover, when a visualization application is used to operate a cursor, the arm is required to be hung in air and maintained to a fixed height, which is inconvenient for the user in operation.

### SUMMARY

The invention is directed to a method for operating an electronic apparatus, by which a user is capable of operating the electronic apparatus in a stereoscopic space, which improves utilization convenience.

The invention is directed to an electronic apparatus, which obtains moving information of an operation object by using a sensor module, such that the electronic apparatus is unnecessary to install a trackpad to save a palmrest region, so as to decrease the size of the electronic apparatus.

The invention provides a method for operating an electronic apparatus, wherein the electronic apparatus includes a sensor module. The method includes following steps. A space operation mode is enabled when an operation object is detected in a sensing space by the sensor module, where under the space operation mode, the sensing space is defined into a plurality of using spaces, and each of the using spaces has a corresponding control function. Under the space operation mode, the control function corresponding to a current space of the sensing space in which the operation object is located is enabled. Moving information of the operation object is detected by the sensor module, and an operation action corresponding to the enabled control function is executed.

The invention provides an electronic apparatus including a sensor module, a processing unit and a storage unit. The sensor module detects movement of an operation object in a sensing space. The processing unit is coupled to the sensor module. The storage unit is coupled to the processing unit, and includes space configuration information. When the sensor module detects the operation object in the sensing space, the processing unit enables a space operation mode. Under the space operation mode, the sensing space is defined into a plurality of using spaces, and each of the using spaces has a corresponding control function. The processing unit enables the control function corresponding to a current space of the sensing space in which the operation object is located. Moreover, the processing unit detects moving information of the operation object by using the sensor module, and executes an operation action corresponding to the enabled control function.

According to the above descriptions, the sensor module is used to detect the movement of the operation object, such that the user is capable of operating the electronic apparatus in the stereoscopic space, which improves utilization convenience. In this way, operations in the stereoscopic space are used to replace the trackpad of the electronic apparatus, such that the trackpad is unnecessary to be installed to save the palmrest region, so as to decrease the size of the electronic apparatus.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block diagram of an electronic apparatus according to an embodiment of the invention.

FIG. 2 is a schematic diagram of a sensor module according to an embodiment of the invention.

FIG. 3 is a flowchart illustrating a method for operating an electronic apparatus according to an embodiment of the invention.

FIG. 4 is a schematic diagram of a sensing space according to an embodiment of the invention.

FIG. 5 is a flowchart illustrating a mode switching method according to an embodiment of the invention.

FIG. 6 is a schematic diagram of a sensing space and moving tracks according to an embodiment of the invention.

FIG. 7 is a schematic diagram of a sensing space and moving tracks according to another embodiment of the invention.

FIG. 8 is a schematic diagram of a sensing range according to an embodiment of the invention.

FIG. 9 is a flowchart illustrating a determination method of cursor movement according to an embodiment of the invention.

FIG. 10 is a flowchart illustrating a determination method of a clicking action according to an embodiment of the invention.

### DETAILED DESCRIPTION OF DISCLOSED EMBODIMENTS

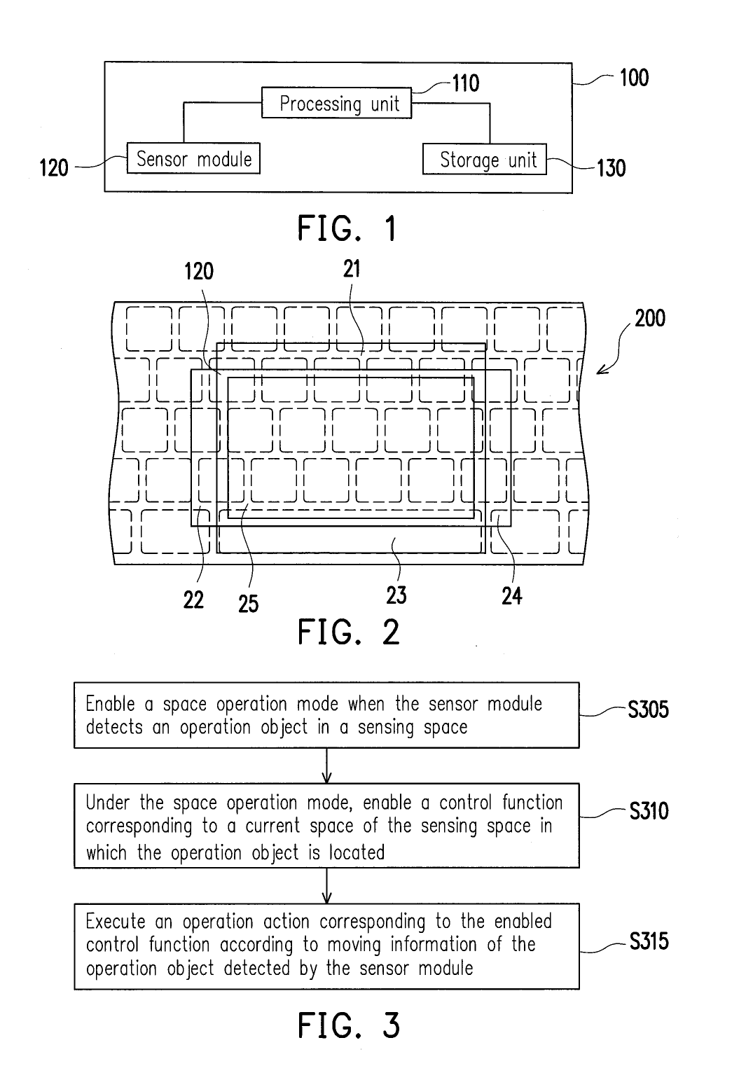

FIG. 1 is a block diagram of an electronic apparatus according to an embodiment of the invention. Referring to FIG. 1, the electronic apparatus 100 includes a processing unit 110, a sensor module 120 and a storage unit 130. The processing unit 110 is coupled to the sensor module 120 and the storage unit 130.

The sensor module 120 includes at least one sensor. The sensor is, for example, a near field sensor. For example, in order to improve detection accuracy, 5 sensors are used to construct the sensor module 120. FIG. 2 is a schematic diagram of a sensor module according to an embodiment of the invention. Referring to FIG. 2, the sensor module 120 includes 5 sensors 21-25 disposed under a keyboard 200. Here, moving information of an operation object is obtained through the sensor module 120 and is transmitted to software in the electronic apparatus 100, and through determination and control of the software, a function of a trackpad is achieved.

The sensor 25 is surrounded by the sensor 21, the sensor 22, the sensor 23 and the sensor 24. The sensors 21-24 are in charge of detecting movement (a variation amount on an XY plane) of the operation object along an X-axis and a Y-axis, and the sensor 25 is in charge of detecting movement (a height variation) of the operation object along a Z-axis. Taking the operation object of a palm as an example, after the processing unit 110 receives raw data of the sensors 21-25, the processing unit 110 can analyse the number of fingers and operation actions thereof according to a plurality sets of signal strengths detected by the sensors 21-25. For example, when variation amounts detected by the sensor 21 and the sensor 22 are greater than that detected by the sensors 23 and 24, it represents that an index finger performs a clicking action. In this way, the above method can be used to determine whether a corresponding mouse click function is executed.

Moreover, in other embodiments, 1-4 or more than 5 sensors can be used to serve as the sensor module 120, and the number of the sensors is not limited by the invention.

FIG. 3 is a flowchart illustrating a method for operating an electronic apparatus according to an embodiment of the invention. Referring to FIG. 1 and FIG. 3, in step S305, when the sensor module 120 detects the operation object in a sensing space, the processing unit 110 enables a space operation mode. The sensing space is a sensing range of the sensor module 120. The control function is, for example, a virtual trackpad function, a gesture operation function, a cursor control function, etc. The space operation mode represents that the processing unit 110 can execute a corresponding control function according to the moving information of the operation object in the sensing space.

Under the space operation mode, the sensing space is defined into a plurality of using spaces, and at least one control function can be triggered according to moving information of the operation object detected in each of the using spaces. For example, a following method can be used for implementation, i.e. a database is created in the storage unit 130 to store space configuration information. The space configuration information records a range of coordinates that can be sensed by the sensor module 120 in the stereoscopic space (i.e. a coordinate range of the sensing space), and coordinate ranges of a plurality of using spaces are divided in advance according to an actual requirement.

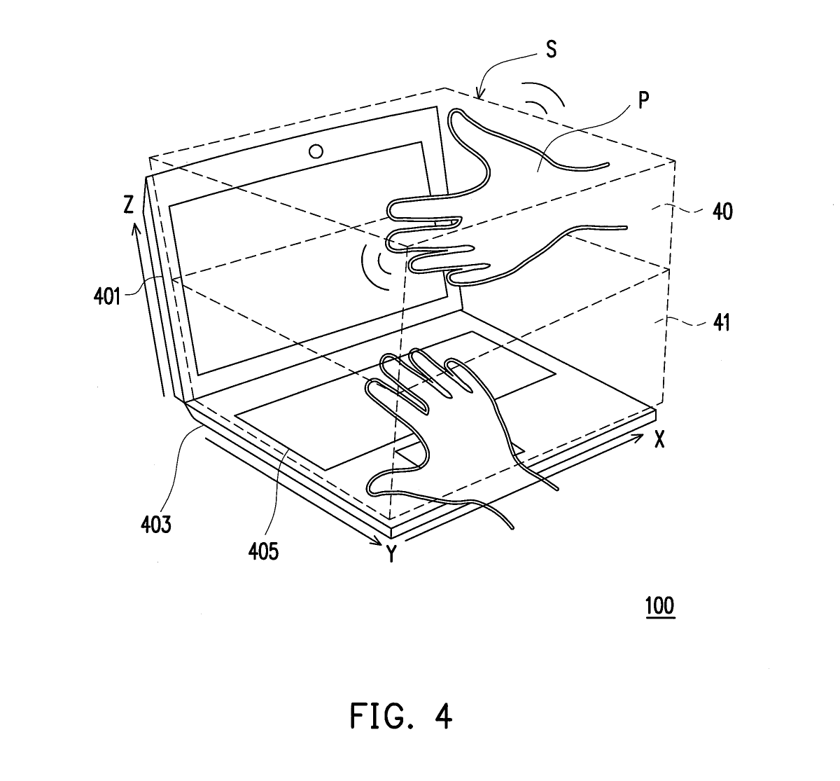

Another embodiment is provided below to describe the sensing space. FIG. 4 is a schematic diagram of a sensing space according to an embodiment of the invention. In the present embodiment, the electronic apparatus 100 is, for example, a notebook computer, and the operation object is, for example, a palm P. However, in other embodiments, the operation object can also be other objects that can be detected by the sensor module 120, for example, a stylus, etc., which is not limited by the invention.

In FIG. 4, the electronic apparatus 100 is configured with a keyboard 405 on a base 403, and the sensor module 120 of FIG. 1 is disposed under the keyboard 405, where configuration of the sensor module 120 is as that shown in FIG. 2. A sensing space S is located above the base 403 (the keyboard 405) and in front of a display unit 401, i.e. a space formed between the base 403 and the display unit 401. Here, the sensing space S is defined into a using space 40 and a using space 41. However, in other embodiments, the number of the using spaces included in the sensing space S is not limited.

The more the operation object is close to the using space of the sensor module 120, the more accurate the raw data obtained by the sensor module 120 is. Therefore, data of the space configuration information of the electronic apparatus 100 can be set as follows (i.e. stored in the storage unit 130). The base 403 is taken as an origin of the Z-axis, 0-10 cm of the Z-axis is set as the using space 41, and the control function corresponding to the using space 41 is set as the virtual trackpad function; 10-20 cm of the Z-axis is set as the using space 40, and the control function corresponding to the using space 40 is set as the gesture operation function. Namely, in the using space 41, the palm P can execute the functions equivalent to that of a physical trackpad, and in the using space 40, the palm P can execute a page turning function or a zooming function, etc. through a swipe gesture or a hover gesture, etc. It should be noticed that the two palms P illustrated in FIG. 4 are used to describe a situation that the palm P can respectively perform an action in the using space 40 and the using space 41 other than simultaneously performing actions in both of the using space 40 and the using space 41. Moreover, the above concept is only an example, and the invention is not limited thereto.

Moreover, under the space operation mode, the processing unit 110 moves a cursor displayed in the display unit 401 of the electronic apparatus 100 according to a moving track of the operation object (the palm P) detected by the sensor module 120. Namely, when the palm P moves in the using space 40 or the using space 41, the processing unit 110 moves the cursor according to the moving track of the palm P on the XY plane.

Therefore, under the space operation mode, the user is unnecessary to touch a physical input unit such as the keyboard 405, a mouse or a trackpad of the electronic apparatus 100, and the sensor module 120 directly detects the movement of the palm P in the sensing space S, so as to operate the functions of the electronic apparatus 100.

Referring to FIG. 3, in step S310, under the space operation mode, the processing unit 110 enables the control function corresponding to a current space of the sensing space in which the operation object is located. Namely, the processing unit 110 determines the current space of the operation object according to the position of the operation object detected by the sensor module 120, so as to enable the control function corresponding to the current space (i.e. the using space where the operation object is currently located).

Then, in step S315, the processing unit 110 executes an operation action corresponding to the enabled control function according to the moving information of the operation object detected by the sensor module 120. The moving information includes a moving direction, a moving track, a moving speed and a movement variation amount, etc. Taking FIG. 4 as an example, when the sensor module 120 detects that the current space in which the palm P (the operation object) is located is the using space 40, the processing unit 110 enables the gesture operation function. When the sensor module 120 detects that the current space in which the palm P is located is the using space 41, the processing unit 110 enables the virtual trackpad function.

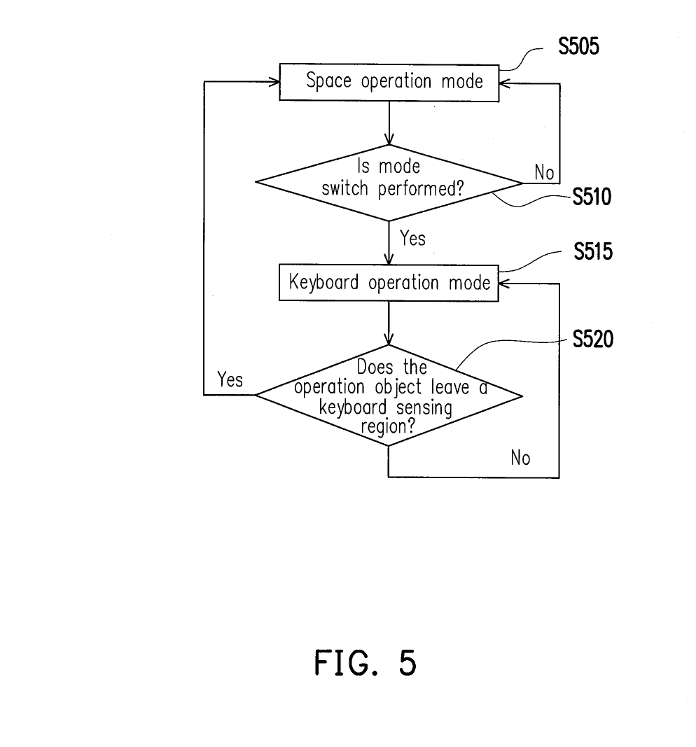

Moreover, when one or more keys of the keyboard of the electronic apparatus 100 are enabled, or one or more preset hotkeys are enabled, or when the operation object is detected to execute a specific operation action, the processing unit 110 disables the space operation mode, and enables a keyboard operation mode. Switch between the space operation mode and the keyboard operation mode is described below. FIG. 5 is a flowchart illustrating a mode switching method according to an embodiment of the invention. Referring to FIG. 1 and FIG. 5, and the flowchart of FIG. 3 is referred for descriptions.

In step S505, the processing unit 110 enables the space operation mode. Here, the description of the step S305 of FIG. 3 can be referred for enabling of the space operation mode, which is not repeated. Then, in step S510, the processing unit 110 determines whether to switch the mode. For example, the processing unit 110 determines whether one or more keys of the keyboard are enabled, or whether one or more preset hotkeys are enabled. Moreover, the processing unit 110 can also determine whether the operation object executes the specific operation action.

Then, when the processing unit 110 determines that the mode is to be switched, in step S515, the processing unit 110 switches the operation mode to the keyboard operation mode. Moreover, the processing unit 110 disables the space operation mode to avoid wrong operation. Then, in step S520, the processing unit 110 determines whether the operation object leaves a keyboard sensing region. For example, the region with a distance spaced from the trackpad below 40 mm is set as the keyboard sensing region. When it is detected that the operation object leaves the keyboard sensing region, it is determined that the user completes typing, and the flow returns to the step S505 to again enable the space operation mode. When it is detected that the operation object does not leave the keyboard sensing region, the keyboard operation mode is maintained.

The applicable switching methods have following three implementations, though the invention is not limited thereto. In the first implementation, a key pressing setting is taken as an example, under the space operation mode, the user can press any key on the keyboard to disable the space operation mode and switch to the keyboard operation mode to enable the keyboard, and the user can move the palm upwards or shake the palm to restore the space operation mode. In the first implementation, the keyboard is not disabled under the space operation mode. In the second implementation, a hotkey setting is taken as an example, and switch between the space operation mode and the keyboard operation mode is implemented by double clicking a “Caps Lock” key quickly. In the second implementation, under the space operation mode, only the set hotkeys can be enabled, and the other keys in the keyboard are disabled. In the third implementation, the operation object executing a specific operation action is taken as an example, a set of gestures are set to disable the space operation mode. In the third implementation, when the space operation mode is switched, the keyboard can be further disabled. Moreover, when the sensing space is defined into a plurality of the using spaces, different control function can be switched under the space operation mode. Taking FIG. 4 as an example, in case that the operation object is in the using space 40 to enable the gesture operation function, the processing unit 110 can automatically disable the virtual trackpad function of the using space 41 to avoid the cursor moving around.

Moreover, before the control function corresponding to the current space where the operation object is located is enabled (referring to the step S310 of FIG. 3), the processing unit 110 further determines whether a moving track of the operation object detected by the sensor module 120 is complied with a default rule, and when the moving track is complied with the default rule, the control function corresponding to the current space is enabled. Namely, movement of the operation object in the using spaces has a specific order, which is described in detail below.

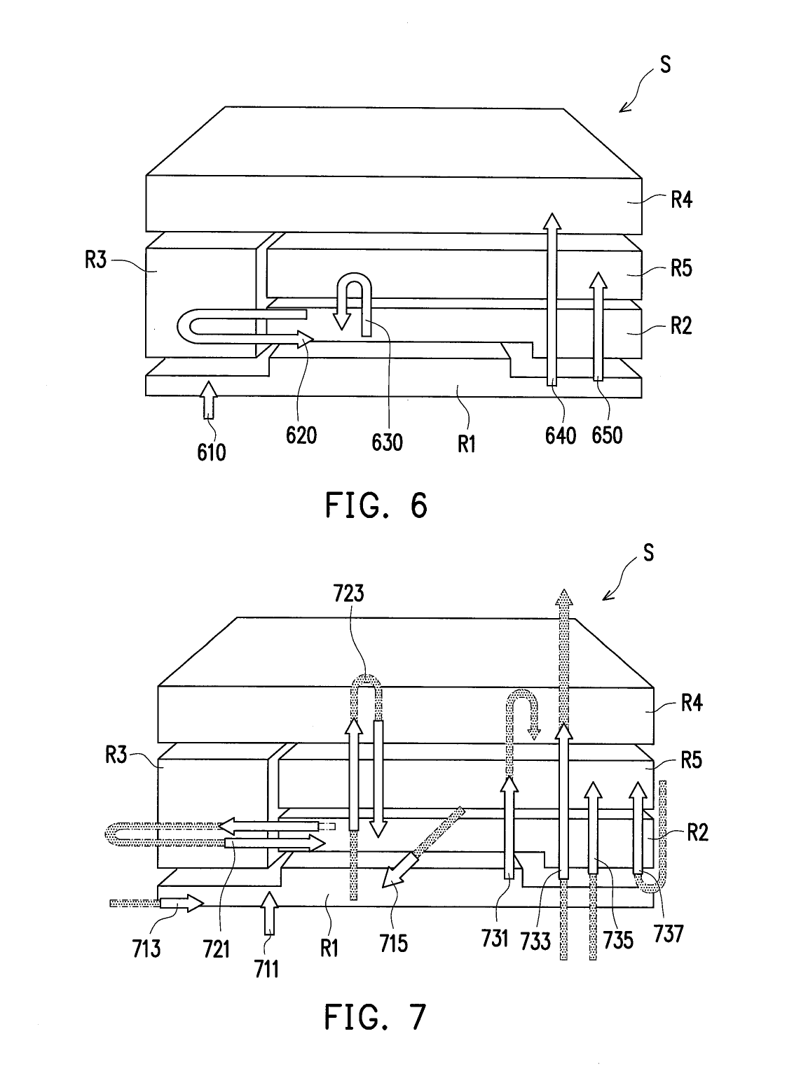

FIG. 6 is a schematic diagram of a sensing space and moving tracks according to an embodiment of the invention. In the present embodiment, in a coordinate range of a sensing space S of the space configuration information in the storage unit 130, coordinate ranges of using spaces R1-R5 are defined, as that shown in FIG. 6. Control functions corresponding to the using spaces R1-R5 are further defined in the space configuration information. The control functions corresponding to the using spaces R1-R5 are set as follows such that the using spaces R1-R5 may correspond to different functions. When moving information of the operation object is detected in one of the using spaces R1-R5, the processing unit 110 can trigger the corresponding control function according to the moving information.

In the present embodiment, besides that the using space R1 has a specific control function (for example, the virtual trackpad function), the using spaces R2-R5 do not have specific control functions, and the control functions thereof can be set by the user. For example, a database is created in the storage unit 130, and the user can store defined moving tracks and corresponding control functions in the database in advance. In this way, when a moving track is detected, the processing unit 110 can query the control function corresponding to the moving track from the database, so as to read a corresponding gesture operation instruction to execute a corresponding operation action.

Here, it is assumed that the using space R1 has the control function A. A default rule of enabling the control function A is follows: as long as the operation object passes through the using space R1, the processing unit 110 executes the control function A. Even if shown as a moving track 610 where the operation object directly enters the using space R1 from the beginning, the processing unit 110 can also enable the control function A.

Moreover, moving tracks 620 and 630 are set as default rules of executing a control function B, and moving tracks 640 and 650 are set as default rules of executing a control function C. The moving track 630 indicates that the operation object first enters the using space R2, and then moves to the using space R5 and returns back to the using space R2. The moving track 620 indicates that the operation object first enters the using space R2, and then moves to the using space R3 and returns back to the using space R2. When the moving track 620 or the moving track 630 is detected, the processing unit 110 executes the control function B.

The moving track 640 indicates that the operation object enters from the using space R1, and sequentially moves towards the using spaces R2, R5 and R4. The moving track 650 indicates that the operation object enters from the using space R1, and sequentially moves towards the using spaces R2 and R5. In this way, when the moving track 640 or the moving track 650 is detected, the processing unit 110 executes the control function C.

Moreover, other applicable moving tracks can also be set. FIG. 7 is a schematic diagram of a sensing space and moving tracks according to another embodiment of the invention. Referring to FIG. 7, in the coordinate range of the sensing space S, coordinate ranges of the using spaces R1-R5 are defined. In the present embodiment, the using space R1 still has the specific control function A, the using spaces R2-R5 do not have specific control functions, and the control functions thereof can be set by the user. For example, the user can store the defined moving tracks and the corresponding control functions in the database in advance.

Moving tracks 711-715, 721-723 and 731-737 are shown in solid line arrows, which can also be extended to tracks as that shown in dot lines. When the moving track 711, 713 or 715 is detected, the processing unit 110 executes the control function A. When the moving track 721 or 723 is detected, the processing unit 110 executes the control function B. When the moving track 731, 733, 735 or 737 is detected, the processing unit 110 executes the control function C. It should be noticed that the embodiments of FIG. 6 and FIG. 7 are only examples, and the invention is not limited thereto. For example, in other embodiments, it can be defined that each of the using spaces has the corresponding control function.

Moreover, besides that the sensing space can be divided into a plurality of using spaces, the XY plane can also be defined into a plurality of control regions. For example, taking the embodiment of FIG. 4 as an example, in the using space 41 closed to the sensor module 120, a plurality of control regions can be defined on a horizontal plane (i.e. the XY plane) in the sensing space S to obtain region information according to the sensing range of the sensor module 120. Namely, the region information includes a coordinate range of each of the control regions. The region information is, for example, recorded in the database of the storage unit 130. When the enabled control function is the virtual trackpad function (when the palm P serving as the operation object is located in the using space 41), the operation action to be executed is further determined according to a current position of the operation object on the horizontal plane.

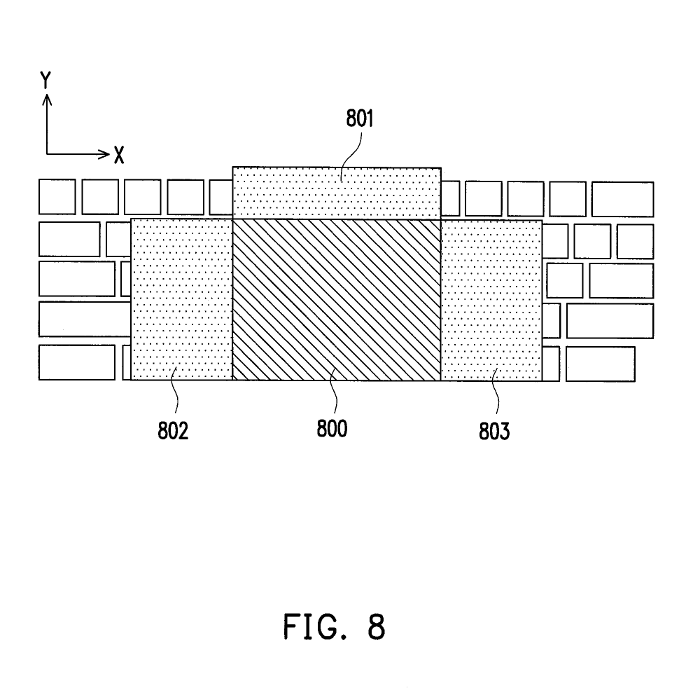

For example, FIG. 8 is a schematic diagram of a sensing range according to an embodiment of the invention. Referring to FIG. 8, four control regions including a main region 800, a top edge region 801, a left edge region 802 and a right edge region 803 are defined in the horizontal plane. Here, configuration of the sensor module 120 is similar to that of the embodiment of FIG. 2, so that related descriptions thereof are omitted.

The main region 800 is the sensing range of the sensor module 120, i.e. the sensor module 120 is located under the main region 800. In the left edge region 802 and the right edge region 803, although a variation amount along the X-axis cannot be detected, a variation amount along the Y-axis can still be detected. In the top edge region 801, although the variation amount along the Y-axis cannot be detected, the variation amount along the X-axis can still be detected. In this way, an operation action corresponding to the main region 800 can be set as a cursor control action. An operation action corresponding to the top edge region 801 can be set as an edge swiping action. An operation action corresponding to one of the left edge region 802 and the right edge region 803 can be set as a zooming action, and an operation action corresponding to the other one is set as a scrolling action. Here, it is assumed that the left edge region 802 corresponds to the zooming action, and the right edge region 803 corresponds to the scrolling action.

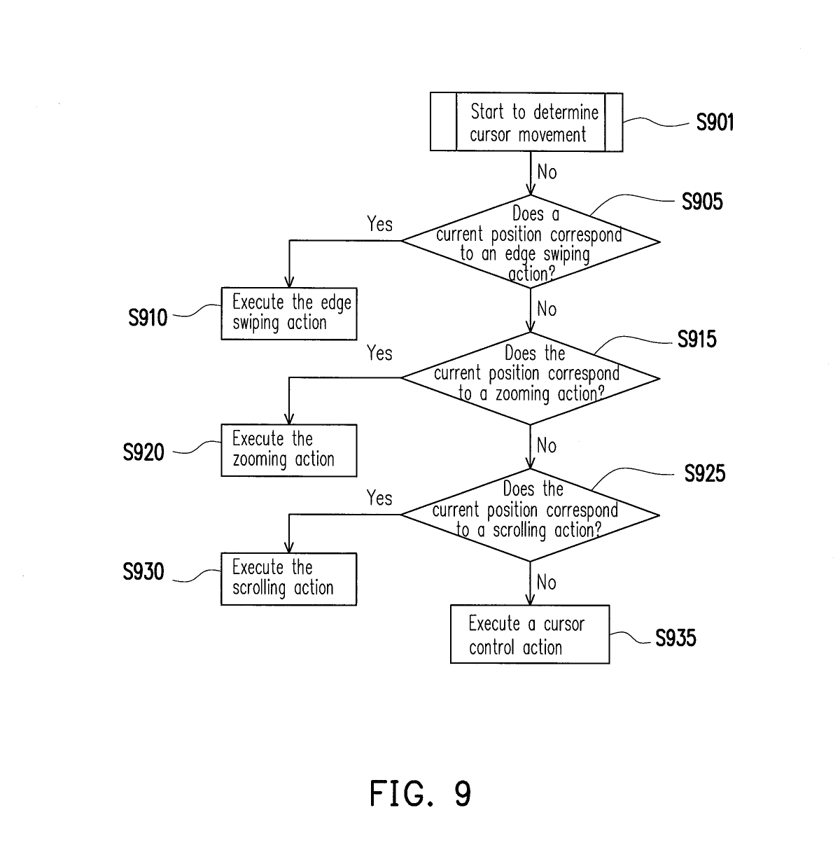

Therefore, when the enabled control function is the virtual trackpad function, the processing unit 110 compares the current position of the operation object on the horizontal plane with the region information to obtain the control region corresponding to the current position of the operation object. The current position of the operation object is compared with the region information in the storage unit 130 to determine whether to execute the edge swiping action, the scrolling action or the zooming action. Another embodiment is described below with reference of FIG. 9.

FIG. 9 is a flowchart illustrating a determination method of cursor movement according to an embodiment of the invention. Referring to FIG. 9, in step S901, determination of cursor movement is started. In step S905, the processing unit 110 determines whether the current position of the operation object corresponds to the edge swiping action. For example, the detected current position of the operation object is compared with the coordinate range of the top edge region 801 in the region information to learn whether the current position of the operation object is located in the top edge region 801.

If the current position of the operation object is located in the top edge region 801, in step S910, the processing unit 110 executes the edge swiping action according to a gesture (for example, detecting a variation amount of the operation object along the X-axis (a first direction)). If the current position of the operation object is not located in the top edge region 801, a step S915 is executed.

In the step S915, the processing unit 110 determines whether the position of the operation object corresponds to the zooming action. For example, the detected current position of the operation object is compared with the coordinate range of the left edge region 802 in the region information to learn whether the current position of the operation object is located in the left edge region 802. If yes, the processing unit 110 detects a variation amount of the operation object along the Y-axis (a second direction), so as to execute the zooming action according to the gesture as that shown in step S920. If the current position of the operation object is not located in the left edge region 802, a step S925 is executed.

In the step S925, the processing unit 110 determines whether the position of the operation object corresponds to the scrolling action. Similar to the above descriptions, the detected current position of the operation object is compared with the coordinate range of the right edge region 803 in the region information to learn whether the current position of the operation object is located in the right edge region 803. If yes, the processing unit 110 detects a variation amount of the operation object along the Y-axis, so as to execute the scrolling action according to the gesture as that shown in step S930.

If the current position of the operation object is located in none of the top edge region 801, the left edge region 802 and the right edge region 803, a step S935 is executed. In the step S935, the processing unit 110 executes a cursor control action. When the current position of the operation object is located in the main region 800, the processing unit 110 detects variation amounts of the operation object along the X-axis (the first direction) and the Y-axis (the second direction) to correspondingly move the cursor. An execution sequence of the above steps S905, S915 and S925 is only an example, and in other embodiments, the execution sequence is not limited.

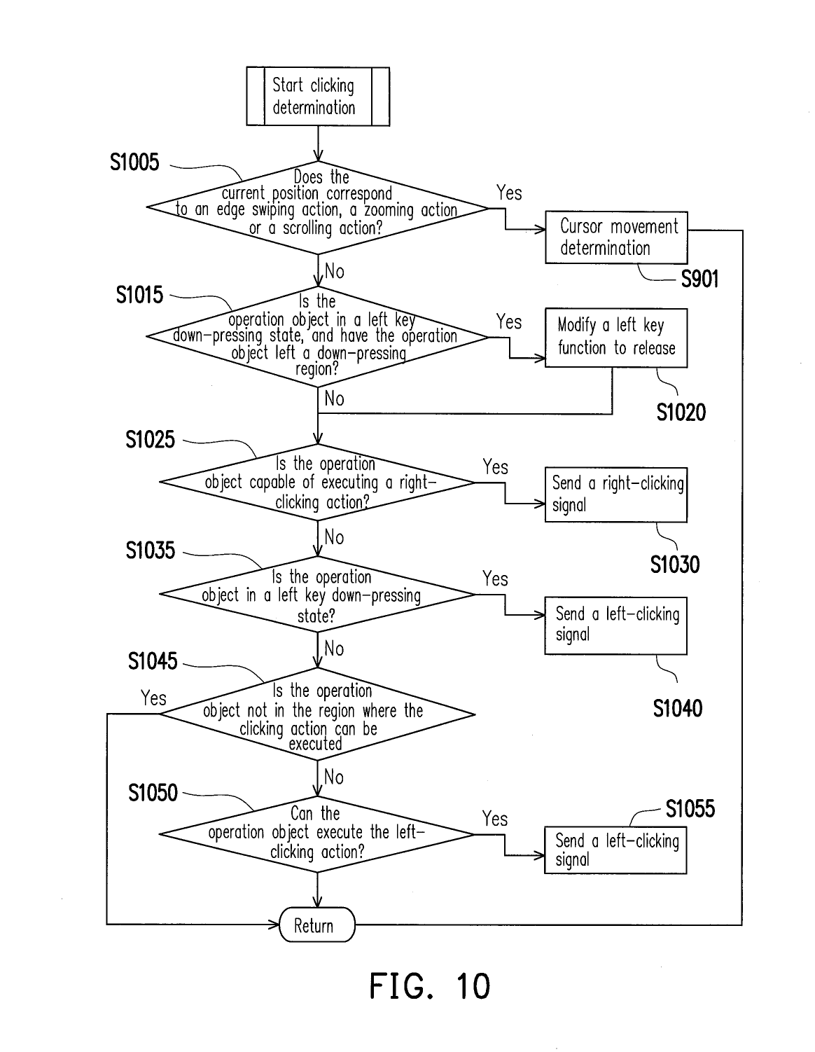

Another embodiment is provided below to describe how to determine a clicking action of the operation object when the enabled control function is the click function. FIG. 10 is a flowchart illustrating a determination method of a clicking action according to an embodiment of the invention. In the present embodiment, it is assumed that in the sensing space, when a height of the operation object along a Z-axis is greater than a threshold (for example, 40 mm), the click function is enabled. Referring to FIG. 2, FIG. 6 and FIG. 8, the click function corresponds to a space (a protrusion portion) above the main region 800 in the using space R1, and the sensor 25 is used to detect the variation amount of the operation object along the Z-axis.

The processing unit 110 compares a vertical variation amount of the operation object along a vertical axial direction (the Z-axis direction) with click operation information based on a moving direction and a position of the operation object, so as to determine whether to execute the clicking action. The clicking action is a right-clicking action or a left-clicking action.

Referring to FIG. 10, in step S1005, the processing unit 110 determines whether the current position of the operation object corresponds to the edge swiping action, the zooming action or the scrolling action. If yes, the step S901 is executed, and the processing unit 110 starts to determine the cursor movement, i.e. executes the steps S905-S935. If not, in step S1015, the processing unit 110 determines whether the operation object is in a left key down-pressing state and the operation object has left a down-pressing region. For example, referring to FIG. 8, the main region 800 is regarded as a trackpad, and has functions the same with that of the trackpad. The main region 800 can be configured with a left key down-pressing region and a right key down-pressing region. In this way, the processing unit 110 compares the current position of the operation object and the vertical variation amount of the operation object along the vertical axial direction with the click operation information in the database, and determines whether the operation object is in the left key down-pressing state, and detects that the operation object has left the down-pressing region.

If the determination result of the step S1015 is negative, a step S1025 is executed; conversely, and if the determination result of the step S1015 is affirmative, a step S1020 is executed, by which the processing unit 110 modifies a left key function to release. Then, in the step S1025, it is determined whether the operation object can execute the right-clicking action. The moving direction and the current position of the operation object are compared with the click operation information in the database to determine whether the right-clicking action can be executed.

If the determination result of the step S1025 is affirmative, a step S1030 is executed, by which the processing unit 110 sends a right-clicking signal. If the determination result of the step S1025 is negative, a step S1035 is executed, by which the processing unit 110 compares the moving direction and the current position of the operation object with the click operation information in the database to determine whether the operation object is in the left key down-pressing state. If yes, a step S1040 is executed, by which the processing unit 110 sends a left key down-pressing signal.

If the determination result of the step S1035 is negative, the processing unit 110 compares the current position of the operation object with the click operation information in the database, and further determines whether the operation object is not in the region where the clicking action can be executed. If the operation object is not in the region where the clicking action can be executed, the flow returns to the step S1005 to re-execute the click determination. If operation object is in the region where the clicking action can be executed, in step S1050, the moving direction and the position of the operation object are compared with the click operation information in the database to determine whether the left-clicking action can be executed. If yes, a step S1055 is executed to send the left-clicking signal. If not, the step S901 is executed to enter the cursor movement determination.

Moreover, in the aforementioned methods, in case that the sensor module 120 is used to detect the gesture of the user, so as to operate and control the electronic apparatus 100, due to a difference in palm width, length and thickness of each person, in order to avoid wrong judgement and a problem of system operation, when the user uses the electronic apparatus 100 for the first time, the electronic apparatus may activate a learning function, i.e. when the user puts the hand on the keyboard, the processing unit 110 detects and records characteristics and related values of the user's hand through the sensor module 120. In this way, when the palm width, length and thickness of the user are different, the processing unit 110 performs calculation and determination according to the initially recorded related values in collaboration with data obtained during the user's operation, so as to avoid wrong judgement.

Moreover, according to the aforementioned method, when the user performs a gesture operation, the software may further predict an advancing direction or a function to be executed by the user according to a subtle action of the user performed during the gesture operation, such that the operation can be more smooth and in line with consumer's habits.

In summary, the sensor module is used to detect the movement of the operation object, such that the user is capable of operating the electronic apparatus in the stereoscopic space, which improves utilization convenience. In this way, operations in the stereoscopic space are used to replace the trackpad of the electronic apparatus, such that the trackpad is unnecessary to be installed to save the palmrest region, so as to decrease the size of the electronic apparatus. Moreover, a multi-layer operation mode can be provided to the user, i.e. the sensing space is further divided into a plurality of using spaces, such that multiple control functions can be executed in the sensing space. Moreover, switch of the modes can be automatically executed according to a height of the user's palm (the operation object) from the keyboard (a height on the Z-axis), so as to improve utilization convenience.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A method for operating an electronic apparatus, wherein the electronic apparatus comprises a sensor module, the method for operating the electronic apparatus comprising:
enabling a space operation mode when the sensor module detects an operation object in a sensing space, wherein under the space operation mode, the sensing space is defined into a plurality of using spaces, and each of the using spaces has a corresponding control function;
under the space operation mode, enabling the control function corresponding to a current space of the sensing space in which the operation object is located; and
detecting moving information of the operation object by the sensor module, and executing an operation action corresponding to the enabled control function.

2. The method for operating the electronic apparatus as claimed in claim 1, further comprising:
before the step of enabling the control function corresponding to the current space, determining whether a moving track of the operation object detected by the sensor module is complied with a default rule, and enabling the control function corresponding to the current space when the moving track is complied with the default rule.

3. The method for operating the electronic apparatus as claimed in claim 1, further comprising:
disabling the space operation mode and switching to a keyboard operation mode when a key of a keyboard of the electronic apparatus is enabled, or a preset hotkey is enabled, or when the operation object is detected to execute a specific operation action.

4. The method for operating the electronic apparatus as claimed in claim 1, further comprising:
under the space operation mode, moving a cursor displayed in a display unit of the electronic apparatus based on a moving track of the operation object detected by the sensor module.

5. The method for operating the electronic apparatus as claimed in claim 1, after the step of enabling the control function corresponding to the current space, the method further comprises:
executing following steps when the control function is a virtual trackpad function:
comparing a current position of the operation object on a horizontal plane with region information, wherein the region information is obtained by defining a plurality of control regions on the horizontal plane in the sensing space according to a sensing range of the sensor module, so as to obtain one of the control regions where the current position of the operation object is located;
wherein when the current position is located at a main region of the control regions, a first variation amount of the operation object along a first direction and a second variation amount of the operation object along a second direction are detected; when the current position is located at a top edge region of the control regions, the first variation amount of the operation object along the first direction is detected; and when the current position is located at a left edge region or a right edge region of the control regions, the second variation amount of the operation object along the second direction is detected.

6. The method for operating the electronic apparatus as claimed in claim 1, wherein the top edge region corresponds to an edge swiping action, one of the left edge region and the right edge region corresponds to a zooming action, the other one of the left edge region and the right edge region corresponds to a scrolling action, and the main region corresponds to a cursor control action.

7. The method for operating the electronic apparatus as claimed in claim 1, wherein after the step of enabling the control function corresponding to the current space, the method further comprises:
comparing a vertical variation amount of the operation object along a vertical axial direction with click operation information based on a moving direction and the current position of the operation object, so as to determine whether to execute a clicking action.

8. The method for operating the electronic apparatus as claimed in claim 7, wherein the clicking action is a right-clicking action or a left-clicking action.

9. The method for operating the electronic apparatus as claimed in claim 1, wherein the moving information comprises a moving direction, a moving track, a moving speed and a moving variation amount.

10. The method for operating the electronic apparatus as claimed in claim 1, wherein the sensor module comprises at least one sensor.

11. An electronic apparatus, comprising:
a sensor module, detecting movement of an operation object in a sensing space;
a processing unit, coupled to the sensor module; and
a storage unit, coupled to the processing unit, and comprising space configuration information, wherein the space configuration information records coordinate ranges of a plurality of using spaces defined in the sensing space, and a control function corresponding to each of the using spaces under the space operation mode,
wherein when the sensor module detects the operation object in the sensing space, the processing unit enables the space operation mode; the processing unit enables the control function corresponding to a current space of the sensing space in which the operation object is located; and the processing unit detects moving information of the operation object by using the sensor module, and executes an operation action corresponding to the enabled control function.

12. The electronic apparatus as claim in claim 11, wherein the sensor module comprises a first sensor, a second sensor, a third sensor, a fourth sensor and a fifth sensor, wherein the fifth sensor is surrounded by the first sensor, the second sensor, the third sensor and the fourth sensor, and the fifth sensor is in charge of detecting movement of the operation object along a Z-axis, and the first sensor, the second sensor, the third sensor and the fourth sensor are in charge of detecting movement of the operation object along an X-axis and a Y-axis.

13. The electronic apparatus as claim in claim 11, wherein before the processing unit enables the control function corresponding to the current space, the processing unit determines whether a moving track of the operation object detected by the sensor module is complied with a default rule, and enables the control function corresponding to the current space when the moving track is complied with the default rule.

14. The electronic apparatus as claim in claim 11, further comprising:
a keyboard, coupled to the processing unit, wherein the sensor module is disposed on the keyboard,
wherein the processing unit disables the space operation mode and switches to a keyboard operation mode when a key of the keyboard is enabled, or a preset hotkey is enabled, or when the operation object is detected to execute a specific operation action.

15. The electronic apparatus as claim in claim 11, further comprising:
a display unit, coupled to the processing unit,
wherein under the space operation mode, the processing unit moves a cursor displayed in the display unit based on a moving track of the operation object detected by the sensor module.
